(19) United States
(12) Patent Application Publication
(10) Pub. No.: US 2009/0231834 A1
(43) Pub. Date: Sep. 17, 2009

(54) Backlight panel and manufacturing method thereof

(76) Inventor: Robert Michael Krohn, Annapolis, MD (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/386,393

(22) Filed: Apr. 17, 2009

Related U.S. Application Data
(63) Continuation of application No. 11/504,515, filed on Aug. 14, 2006, now abandoned.
(60) Provisional application No. 60/708,572, filed on Aug. 16, 2005.

(51) Int. Cl. G09F 13/04

(52) U.S. Cl. 362/97.1

(57) ABSTRACT

The present invention is a fluorescent (or LED) illuminated backlight panel. Cold-cathode lamps, external electrode fluorescent lamps, thin fluorescent lamps, or LED strips are inserted into a transparent or translucent twinwall plastic sheet, similar in construction to corrugated cardboard. The lamp (or LED) spacing is easily changed in order to alter the intensity of the light emitted by the lightpanel, the number of lamps (or LEDs) used and to change the “evenness” of the light across the panel. The twinwall plastic sheet is thin, durable and lightweight, protecting the fragile lamps and providing a simple method of mounting and wiring. The plastic sheet may also be slit on one, or both sides, yielding a flexible lightpanel; graduated dots or lines may be printed onto the surface of the plastic sheet or translucent materials may be used on the surface of the plastic sheet to assist in making the intensity of the light across the surface of the sheet more even.

### CROSS-REFERENCE TO RELATED APPLICATIONS

The present application is a Continuation Application of U.S. patent application Ser. No. 11/504,515, filed Aug. 14, 2006, which further claims the benefit of U.S. Provisional Application No. 60/708,572 filed Aug. 16, 2005.

### BACKGROUND OF THE INVENTION

The present invention relates to a fluorescent (or LED) illuminated backlight panel and more particularly, to an improved backlight panel including a twinwall plastic lampholder sheet, comprised of a multiplicity of longitudinal tubes for properly spacing, housing and protecting the inserted fragile fluorescent lamps or LED strips.

In recent years there has been an industry-wide, customer-driven desire for display lightboxes which are very thin; changes in the Americans With Disabilities Act (ADA) mandated lightboxes that could protrude no more than three inches from the wall. Previously, normal interior-use lightboxes were, on the average, five-to-six inches thick. Through creativity and better engineering, top-quality fluorescent lightboxes were able to be manufactured to about three inches in depth; two-sided lightboxes are typically five to six inches deep.

With the advent of acrylic, edge-lit lightpanels, lightboxes were able to be manufactured to a depth of between one and two inches but at great expense.

However, the standard backlit fluorescent lightboxes are very heavy, relatively deep, use a lot of power and have limited lamp life. Edgelit lightboxes are thin, but they are very heavy, very expensive, very difficult to service and are not very bright. The lamps used in edge-lightpanels, normally CCFL's (cold-cathode fluorescent lamps) or EEFL's (external electrode fluorescent lamps) are extremely fragile. It is also very difficult, in all forms, to make a thin, bright, curved lightbox or lightpanel.

### BRIEF SUMMARY OF THE INVENTION

The present invention is comprised of a thin, tough, hollow, twinwall plastic sheet; into this sheet is inserted one or a series of (parallel) thin fluorescent lamps or LEDs; the tough, rigid, twinwall sheet provides protection for the lamps or LEDs, along with a method for mounting the lights and providing the proper spacing between the lights.

The lamps, either CCFLs, EEFLs, thin fluorescent lamps, or LEDs are protected from shock and breakage by being contained within the tough, rigid, plastic lampholder sheet. By varying the placement of the lamps or LEDs in alternate hollow tubes, the spacing of the lamps or LEDs (the distance between lamps or LEDs) is easily changed, thus altering the numbers of lights and the brightness of the sheet. Double-sided lightboxes can be easily and inexpensively manufactured to under three inches in depth. The rigidity and protection afforded by the plastic lampholder sheet allows for the ease of manufacture of lightpanels for use without the necessity of additional protection by metal or plastic cover-bodies, since the plastic lampholder sheet serves as both protection for the lamps and LEDs and as method of lamp and LED mounting. The present invention may be curved by longitudinally slitting-through a series of the hollow, square tubes on one-or-two sides of the sheet (kerfing), allowing the sheet to bend, yielding a flexible backlight panel.

### BRIEF DESCRIPTION OF DRAWINGS

FIG. 1 Is an end-view of a plastic lampholder sheet, comprised of:

A. Broad parallel wall (#1)

B. Broad parallel wall (#2)

C. Longitudinal rib (#3)

D. Hollow square tube (#4)

FIG. 2 Is a perspective view of a plastic lampholder sheet.

FIG. 3 Is a perspective view showing lamps inserted into a plastic lampholder sheet.

FIG. 4 Is a perspective view of a plastic lampholder sheet in which the hollow square tubes that contain the fluorescent lamps are shorter than the adjacent hollow square tubes, providing for extra protection for the ends of the fluorescent lamps.

FIG. 5 Is a perspective view of a plastic lampholder sheet with fluorescent lamps inserted and wiring harness attached.

FIG. 6 Is a perspective view showing an LED strip inserted into a plastic lampholder sheet

FIG. 7 Is a perspective view of a plastic lampholder sheet which has been slit, cut or otherwise kerfed in order to provide flexibility to the backlight panel.

FIG. 8 Is a close-up of the perspective view of a plastic lampholder sheet which has been slit, cut or otherwise kerfed in order to provide flexibility to the backlight panel.

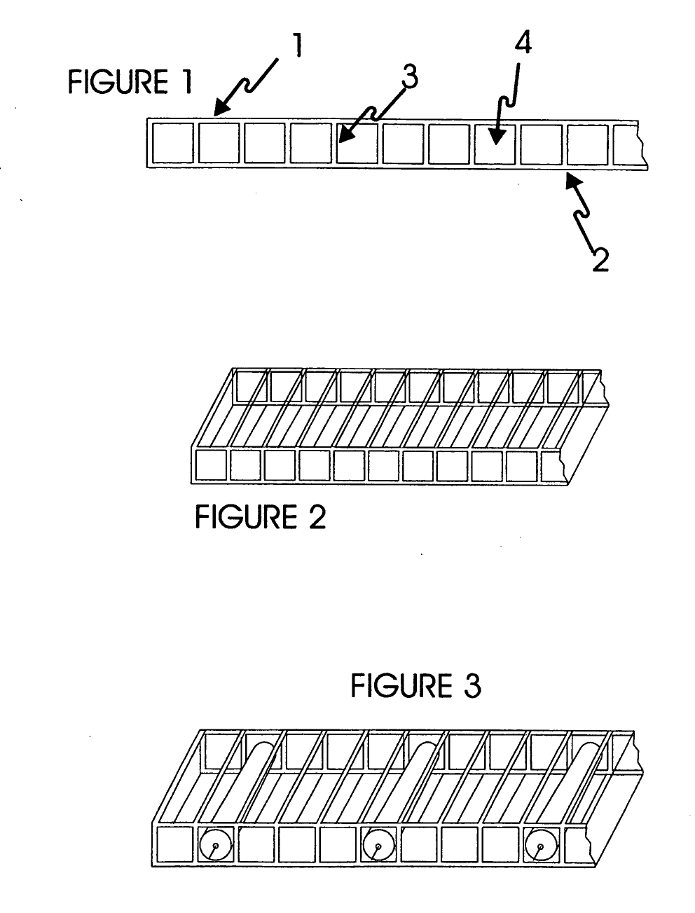

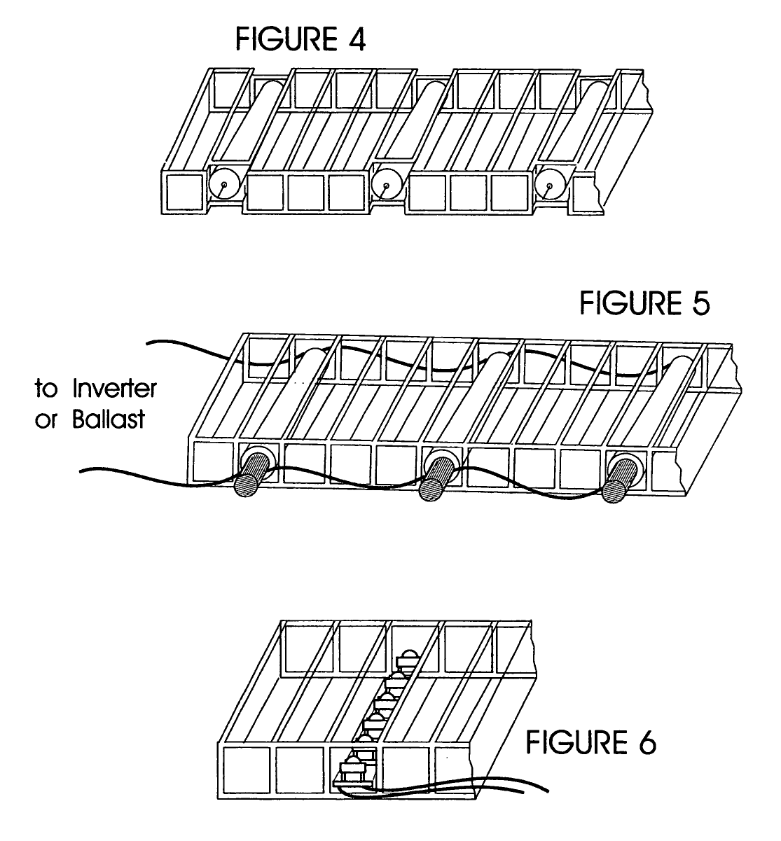

### DETAILED DESCRIPTION OF THE INVENTION

The present invention discloses a backlight including fluorescent lamps or LEDs and a method for driving the same. The backlight is constructed in a manner that a multiplicity of fluorescent lamps or LEDs are inserted into a series of hollow, square, parallel plastic tubes supported between two parallel plastic walls (FIG. 3). The plastic tubes and walls are preferably extruded from polycarbonate, although other plastic types and manufacturing methods may be utilized. Round plastic tubes may also be used.

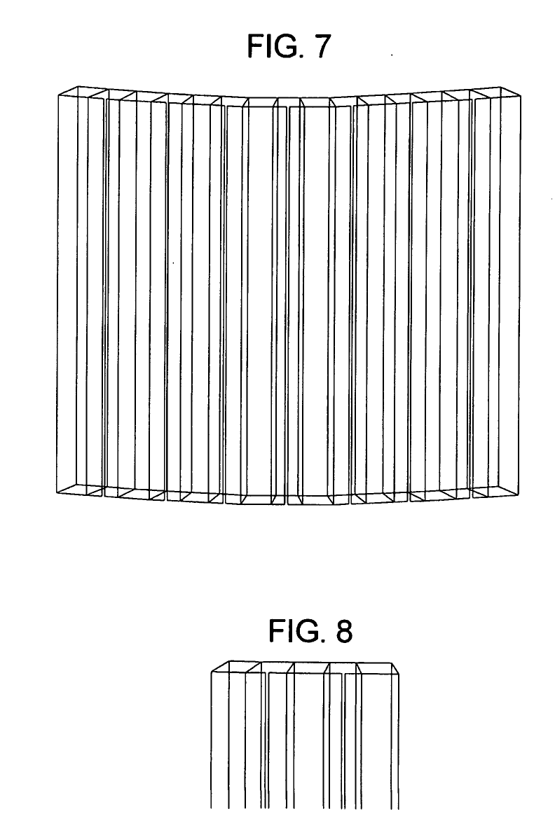

The backlight of the present invention is illuminated via fluorescent lamps or LEDs, employing, but not limited to, cold-cathode fluorescent lamps, external electrode fluorescent lamps or LEDs (FIGS. 3, 5 and 6). These lamps are typically driven by, but are not limited to, commercially available inverters utilizing a square wave, sine wave, fluorescent ballasts or switching power supplies. A wiring harness is utilized to carry the proper voltage, current and frequency to the ends of each lamp or LED (FIGS. 5 and 6).

The present invention is an improvement on the prior art because:

1. The lamps, either CCFLs, EEFLs, thin fluorescent lamps, or LEDs are protected from shock and breakage by being contained within the plastic lampholder sheet, either with or without plastic, rubber or synthetic, square, circular, or shaped “O”-ring types of spacers encircling the lamps.

2. By varying the placement of the lamps or LEDs in alternate hollow square tubes, the spacing of the lamps or LEDs (the distance between lamps) is easily changed. This change in lamp or LED spacing alters the number of lamps or LEDs used in the lightpanel, thus changing the brightness of the lightpanel and altering the distance needed between the plane of the lamps and an illuminated substrate in order to achieve even illumination across the face of the illuminated substrate.

3. The mounting (insertion) of the lamps within the hollow tubes of the transparent or translucent plastic lampholder sheet allows for the very easy manufacture of double-sided lightpanels and lightboxes, since the illumination from the lamps shines out of both sides of the lampholder sheet, if it is transparent or translucent. Double-sided lightboxes can be easily and inexpensively manufactured to under three inches in depth.

4. The imprinting of translucent material, dots, lines or other light-reducing methods onto the face of the square, hollow tubes, directly in front of the lamps, easily allows for increased control of the intensity and evenness of illumination of the light panel.

5. The rigidity and protection afforded by the plastic lampholder sheet allows for the ease of manufacture of lightpanels for use without the necessity of additional protection by metal or plastic cover-bodies, since the plastic lampholder sheet serves as both protection for the lamps and LEDs and as method of lamp and LED mounting.

6. The slitting of one side of the hollow, square tubes(s), parallel to the longitudinal ribs, on one or both sides of the broad, parallel walls, allows the lampholder sheet to bend. This yields a flexible lightpanel.

7. The use of CCFLs, EEFLs or LEDs in the present backlight panel improves the prior backlight panel art due to the long life of the lamps used, requiring less service and maintenance.

8. Because of all of the above, and more, lightpanels, lightboxes and other products manufactured utilizing the present invention are lighter, less expensive, brighter, illuminated more evenly, require less service and are generally thinner than when using other comparable methods of illumination

1. What I claim as my invention is a backlight, comprising:
A transparent plastic lampholder sheet, consisting of two or more broad parallel walls supported by intervening parallel spaced-apart longitudinal ribs, defining a series of hollow square tubes.
One, or a multiplicity of fluorescent lamps, each inserted into one of the aforementioned hollow square tubes.
A wiring harness, each said harness originating at an inverter or ballast and terminating at the electrodes of the aforementioned fluorescent lamp(s) individually or in parallel, depending on the lamp and inverter or ballast type.
An inverter or ballast, connected to said lamp electrodes via the aforementioned wiring harness for applying the necessary waveform, voltage and current to the lamps.

2. The backlight in claim 1, wherein the top and/or bottom of an individual hollow square tube or tubes of said transparent plastic lampholder sheet that houses the fluorescent lamp is imprinted, or colored in some other way, in order to vary the amount of light transmitting out of that square tube. Said imprint may be comprised of a translucent material or a printed pattern of dots, lines or shapes. Said imprint may also be comprised of a translucent adhesive material applied to the face of the square tube above and/or below the fluorescent lamp.

3. The backlight in claim 1, wherein the fluorescent lamp is surrounded at two or more points by a rubber or synthetic, square, circular, or shaped “O”-ring, supporting the lamp away from the walls of the hollow square tubes and also behaving as a shock absorber.

4. The backlight in claim 1, wherein the plastic lampholder sheet is translucent.

5. The backlight in claim 1, wherein the transparent plastic lampholder sheet has one, some or all of the broad, parallel walls colored with a transparent, translucent or opaque white or color, said white or color applied by screenprinting, adhesive sheet application, co-extrusion, or other process.

6. The backlight in claim 1, wherein the plastic lampholder sheet is comprised of two or more broad parallel walls supported by intervening parallel spacedapart, curved longitudinal ribs, defining a series of hollow tubes.

7. The backlight in claim 1, wherein the hollow square tubes in the plastic lampholder sheet which contain the fluorescent lamps are shorter than the adjacent hollow square tubes. This manifestation provides extra protection for the ends of the fluorescent lamps.

8. The backlight in claim 1, wherein some number of square tubes in the lampholder sheet are cut through (kerfed), parallel to the longitudinal ribs, on one of the broad, parallel walls in order to allow the lampholder sheet to bend. Alternate square tubes may be cut, parallel to the longitudinal ribs on both sides of the lampholder sheet, allowing the lampholder sheet to curve in one or two dimensions.

9. The backlight in claim 1, wherein a transparent plastic lampholder sheet, comprised of two or more broad parallel walls supported by intervening parallel spaced-apart longitudinal ribs, defining a series of hollow square tubes, may also be extruded or constructed to define a series of hollow round tubes, or tubes of any desired shape.

10. A backlight, comprising:
A transparent plastic lampholder sheet, consisting of two or more broad parallel walls supported by intervening parallel spaced-apart longitudinal ribs, defining a series of hollow square tubes.
One, or a multiplicity of LED strips (light-emitting-diode strips), each inserted into one of the aforementioned hollow square tubes. Said LED strips are comprised of two or more LED's, placed next to each other, in a line, wired in parallel or in series, attached to a rigid or flexible wiring harness or printed circuit board.
A wiring harness, each wiring harness originating at a DC voltage source, or any other type of voltage source appropriate for powering said LED strips; the other end of the wiring harness terminating at one, some, or all of the LED strips, used to provide power to the LED strips.

11. The backlight in claim 10, wherein a transparent plastic lampholder sheet, comprised of two or more broad parallel walls supported by intervening parallel spaced-apart longitudinal ribs, defining a series of hollow square tubes, may also be extruded or constructed to define a series of hollow round tubes, or tubes of any desired shape.
